(19) United States
(12) Patent Application Publication
(10) Pub. No.: US 2021/0012380 A1
(43) Pub. Date: Jan. 14, 2021

(54) SYSTEM FOR MAKING LOCATION-BASED PROMOTION OVER SOCIAL MEDIA APPLICATIONS

(71) Applicant: TURKCELL TEKNOLOJI ARASTIRMA VE GELISTIRME ANONIM SIRKETI, Istanbul (TR)

(72) Inventor: CANAK, Caner CANAK, Istanbul (TR)

(73) Assignee: TURKCELL TEKNOLOJI ARASTIRMA VE GELISTIRME ANONIM SIRKETI, Istanbul (TR)

(21) Appl. No.: 16/955,708

(22) PCT Filed: Dec. 20, 2018
(86) PCT No.: PCT/TR2018/050845

§ 371 Date: Jun. 18, 2020

(30) Foreign Application Priority Data
Dec. 20, 2017 (TR) 2017/20972

(51) Int. Cl. G06Q 30/02; G06Q 50/00; H04W 4/02; H04W 4/21; H04W 4/23; H04W 8/18

(52) U.S. Cl. CPC G06Q 30/0261; G06Q 50/01; H04W 8/18; H04W 4/21; H04W 4/23; H04W 4/023

(57) ABSTRACT

The present invention relates to a system for enabling companies that sell products and/or services to promote their products and/or services to social media application users over social media applications on the basis of user location.

### TECHNICAL FIELD

The present invention relates to a system for enabling companies that sell products and/or services to promote their products and/or services to social media application users over social media applications on the basis of user location.

### BACKGROUND OF THE INVENTION

Today, use of mobile devices and mobile communication networks show a continuous increase. Mobile devices can obtain location information by means of signal exchanges that they carry out with mobile communication networks. Location information of a detected mobile device are considered as the location information of the subscriber because mobile device are mostly close to the subscriber and various services are created for subscribers or various institutions. These services are called as location based services (LBS).

Location based services provide many information and service to subscribers and institutions and they are essentially based upon being able to determine location of a subscriber. This case is also used by companies to promote the products and/or the services sold by them or the company itself based on the location of their clients or potential clients. For example, when subscriber of a mobile communication network operator enters a shopping mall, promotional messages are sent to the mobile communication device of the said subscriber about on sale products of a company located in the said shopping mall.

In recent years, a fast increase is seen in use of social media applications as well in parallel with increase of use of mobile devices and. mobile communication networks. Almost all mobile device users have account in at least one social media application. Users having social media application account spend a great majority of their times in the said applications. And due to the fact that this case attracts companies' attention, companies perform promotions for the products and/or the services sold by them or the company itself over social media applications in recent years. Moreover, companies can perform promotions for the products and/or the services sold by them or the company itself based on the user location detected by a social media application over social media applications because most social media applications can access current location of a user in accordance with user permission.

However, due to the fact that reception of a user location information by a social media application depends on user permission, companies cannot perform promotions for the products and/or the services sold by them or the company itself based on the user location to users of a social media application who don't allow reception of their location and this causes companies not to be able to access all their clients and target clients over social media application.

Therefore, in the state of the art, there is need for a system which enables companies to perform promotions for the products and/or the services sold by them or the company itself to the said users over social media applications based on the locations of the said users independently of the location detection permission given by users—who have an account in at least one social media application—to the application.

The United States patent document no. US2012197724 discloses a system for detecting location of a user and advertising about nearby places according to the location. A social networking system such as a social networking site enables its users to interact with the system and each other. Typically, an account registry must be made to become a registered user of a social networking system. Thereafter, the registered user may log into the social networking system via an account by providing a correct login ID or username and password. The mobile advertising process receives a geographic location from a user's GPS-equipped mobile phone. These location data are stored in location database. The mobile advertising process accesses the location database and makes list of places comprising one or more of the places within one and a half kilometres from the user's geographic location. The geo-social networking system presents this list created to the accounts of the users included in the social networking systems.

### SUMMARY OF THE INVENTION

An objective of the present invention is to realize a system for enabling companies that sell products and/or services to promote their products and/or services to social media application users over social media applications on the basis of user location comprises

### DETAILED DESCRIPTION OF THE INVENTION

“A System for Making Location-Based Promotion over Social Media Applications” realized to fulfill the objective of the present invention is shown in the figure attached, in which:

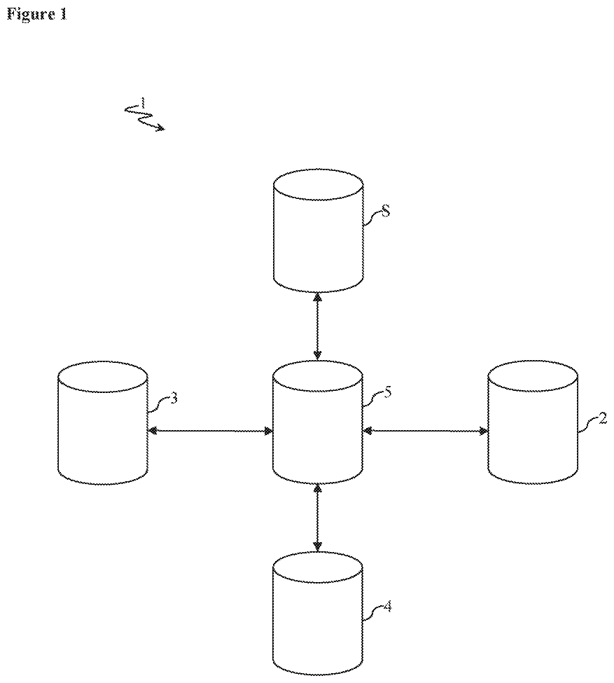

FIG. 1 is a schematic block diagram of the inventive system.

The components illustrated in the figure are individually numbered, where the numbers refer to the following:
1. System
2. Subscriber information database
3. Subscriber location information database
4. Promotion content database
5. Server

S. Social Media Server

The inventive system (1) for enabling companies that sell products and/or services to promote their products and/or services to social media application users over social media applications on the basis of user location comprises:
at least one subscriber information database (2) wherein data of subscribers, who get service from at least one mobile communication network, about at least their account information of the social media application are saved depending on. a distinctive indicator about the subscriber;
at least one subscriber location information database (3) wherein data of subscribers, who get service from at least one mobile communication network, about their location information detected in accordance with the signaling they realize by mobile communication networks by means of their mobile communication devices are saved depending on a distinctive indicator about the said subscriber,
at least one promotion content database (4) which saves the data about the promotional content information about the products and/or the services that companies want to promote, such that the are matched with the data about the pre-determined location information that companies want to promote;
at least one server (5) which is in communication with the subscriber information database (2), the subscriber location information database (3) and the promotion content database (4) and which is configured. in order to detect the subscriber indicator information of the subscribers who have social media information inside the subscriber information database (2) by connecting to the subscriber information database (2) at certain intervals, to query current location. information of the said subscribers by using the subscriber indicator information detected inside the subscriber information database (2) by connecting to the subscriber location information database (3), to control whether there is a promotional content having the location information that matches with the current location information detected in the subscriber location information. database (3) for the subscribers detected as a result of the query transaction inside the subscriber information database (2) by connecting to the promotion content database (4), and to send the data about the promotion and the data about the social media account information of the said subscriber to the social media server (S) in order that the said promotion is provided to the related subscriber over the social media application by establishing communication the social media server (S) that administers the related social media application wherein the subscriber has an account if it is detected as a result of the controlling transaction that there is a promotional content that has the location information matching with the current location information of the subscriber.

The subscriber information database (2) included in the inventive system (1) is in communication with the server (5) and it is configured in order to be administered preferably by a mobile communication network operator. Data about the account information of at least one social media application of subscribers of at least one mobile communication network operator are saved inside the subscriber information database (2) depending on a distinctive indicator about the subscriber. In one embodiment of the invention, the data about the account information of the social media application of subscriber are saved inside the subscriber information database (2) depending on a distinctive indicator that is MSISDN (Mobile Station International Subscriber Directory Number) information about the subscriber.

The subscriber location information database (3) included in the inventive system (1) is in communication. with the server (5) and it is configured in order to be administered preferably by a mobile communication network operator. Data about the location information detected in accordance with the signaling realized by mobile communication networks by means of mobile communication devices of subscribers of at least one mobile communication network operator, are saved inside the subscriber location information database (3) depending on a distinctive indicator about the subscriber on the basis of date and time. In one embodiment of the invention, the data about the location information of the subscriber are saved inside the subscriber location information database (3) depending on a distinctive indicator that is MSISDN (Mobile Station International Subscriber Directory Number) information about the subscriber.

The promotion content database (4) is in communication with the server (5) and it is configured in order to be administered by the server (5). Data about the promotional content information about the products and/or the services that companies want to promote are stored inside the promotion content database (4) such that they are matched with the data about the pre-determined location information that companies want to promote.

The server (5) included in the inventive system (1) is in communication with the subscriber information database (2), the subscriber location information database (3) and the promotion content database (4). The server (5) is configured in order to administer the promotion content database (4) by means of transactions such as making a new data record inside the promotion content database (4), updating the data recorded inside the promotion content database (4) by deleting the data recorded inside the promotion content database (4) or changing the data recorded inside the promotion content database (4). The server (5) is configured in order to detect the subscriber indicator information of the subscribers inside the subscriber information database (2) by connecting to the subscriber information database (2) at certain intervals. Then, the server (5) is configured in order to query current location information of the said subscribers by using the subscriber indicator information detected inside the subscriber information database (2) by connecting to the subscriber location information database (3). Thereafter, the server (5) is configured in order to control whether there is a promotional content having the location information that matches with the current location information detected in the subscriber location information database (3) for the subscribers detected as a result of the query transaction inside the subscriber information database (2) by connecting to the promotion content database (4). The server (5) is configured in order to send the data about the promotion and the data about the social media account information of the said subscriber to the social media server (S) in order that the said promotion is provided to the related subscriber over the social media application by establishing communication the social media server (S) that administers the related social media application wherein the subscriber has an account if it is detected as a result of the controlling transaction that there is a promotional content that has the location information matching with the current location information of the subscriber.

With the inventive system (1), location information of social media application users—who are subscribers of a mobile communication network operator—are detected by means of signaling realized by the user mobile device through the mobile communication. network members instead of obtaining the users' location information from social media application and the product and/or the service or the company itself is promoted to the users, whose locations are detected in this way, over social media application if the user is in a location that is predetermined by the company. Thereby, location-based product and/or service promotion can be made by companies even for users who don't allow location detection feature of social media applications and thus number of clients or target clients who receive product or service promotion of companies is increased.

It is possible to develop various embodiments of the inventive system (1); the invention cannot be limited to examples disclosed herein and it is essentially according to claims.

1. A system (1) for enabling companies that sell products and/or services to promote their products and/or services to social media application users over social media applications on the basis of user location; comprising at least one subscriber information database (2) wherein data of subscribers, who get service from at least one mobile communication network, about at least their account information of the social media application are saved depending on a distinctive indicator about the subscriber;
at least one subscriber location information database (3) wherein data of subscribers, who get service from at least one mobile communication network, about their location information detected in accordance with the signaling they realize by mobile communication networks by means of their mobile communication devices are saved depending on a distinctive indicator about the said subscriber;
at least one promotion content database (4) which saves the data about the promotional content information about the products and/or the services that companies want to promote, such that they are matched with the data about the pre-determined location information that companies want to promote; and characterized by
at least one server (5) which is in communication with the subscriber information database (2), the subscriber location information database (3) and the promotion content database (4) and which is configured in order to detect the subscriber indicator information of the subscribers who have social media information inside the subscriber information database (2) by connecting to the subscriber information database (2) at certain intervals, to query current location information of the said subscribers by using the subscriber indicator information detected inside the subscriber information database (2) by connecting to the subscriber location information database (3), to control whether there is a promotional content having the location information that matches with the current location information detected in the subscriber location information database (3) for the subscribers detected as a result of the query transaction inside the subscriber information database (2) by connecting to the promotion content database (4), and to send the data about the promotion and the data about the social media account information of the said subscriber to the social media server (S) in order that the said promotion is provided to the related subscriber over the social media application by establishing communication the social media server (S) that administers the related social media application wherein the subscriber has an account if it is detected as a result of the controlling transaction that there is a promotional content that has the location information matching with the current location information of the subscriber.

2. A system (1) according to claim 1, characterized by the subscriber information database (2) which is in communication with the server (5) and configured in order to be administered by a mobile communication network operator.

3. A system (1) according to claim 1, characterized by the subscriber information database (2) wherein data about the account information of at least one social media application of subscribers of at least one mobile communication network operator are saved depending on a distinctive indicator about the subscriber.

4. A system (1) according to claim 3, characterized by the subscriber information database (2) which saves the data about the account information of the social media application of subscriber in itself depending on a distinctive indicator that is MSISDN information about the subscriber.

5. A system (1) according to claim 1, characterized by the subscriber location information database (3) which is in communication with the server (5) and configured in order to be administered preferably by a mobile communication network operator.

6. A system (1) according to claim 1, characterized by the subscriber location information database (3) which stores the data about the location information detected in accordance with the signaling realized by mobile communication networks by means of mobile communication devices of subscribers of at least one mobile communication network operator, depending on a distinctive indicator about the subscriber on the basis of date and time.

7. A system (1) according to claim 6, characterized by the subscriber location information database (3) which stores the data about the location information of the subscriber depending on a distinctive indicator that is MSISDN information about the subscriber.

8. A system (1) according to claim 1, characterized by the promotion content database (4) which is in communication with the server (5) and configured in order to be administered by the server (5).

9. A system (1) according to claim 1, characterized by the promotion content database (4) wherein data about the promotional content information about the products and/or the services that companies want to promote are stored such that they are matched with the data about the pre-determined location information that companies want to promote.

10. A system (1) according to claim 1, characterized by the server (5) which is in communication with the subscriber information database (2), the subscriber location information database (3) and the promotion content database (4).

11. A system (1) according to claim 1, characterized by the server (5) which is configured in order to administer the promotion content database (4) by means of transactions such as making a new data record inside the promotion content database (4), updating the data recorded inside the promotion content database (4) by deleting the data recorded inside the promotion content database (4) or changing the data recorded inside the promotion content database (4).

12. A system (1) according to claim 1, characterized by the server (5) which is configured in order to detect the subscriber indicator information of the subscribers inside the subscriber information database (2) by connecting to the subscriber information database (2) at certain intervals.

13. A system (1) according to claim 12, characterized by the server (5) which is configured in order to query current location information of the said subscribers by using the subscriber indicator information detected inside the subscriber information database (2) by connecting to the subscriber location information database (3).

14. A system (1) according to claim 13, characterized by the server (5) which is configured in order to control whether there is a promotional content having the location information that matches with the current location information detected in the subscriber location information database (3) for the subscribers detected as a result of the query transaction inside the subscriber information database (2) by connecting to the promotion content database (4).

15. A system (1) according to claim 14, characterized by the server (5) which is configured in order to send the data about the promotion and the data about the social media account information of the said subscriber to the social media server (S) in order that the said promotion is provided to the related subscriber over the social media application by establishing communication the social media server (S) that administers the related social media application wherein the subscriber has an account if it is detected as a result of the controlling transaction that there is a promotional content that has the location information matching with the current location information of the subscriber.
